(19) United States
(12) Patent Application Publication
(10) Pub. No.: US 2002/0045952 A1
(43) Pub. Date: Apr. 18, 2002

(54) High performance hybrid micro-computer

(76) Inventor: Kenneth G. Blemel, Albuquerque, NM (US)

Correspondence Address: Kenneth G. Blemel, Sentient Sensors, LLC, 6022 Constitution Avenue NE, Albuquerque, NM, 87110-5941, US

(21) Appl. No.: 09/977,140

(22) Filed: Oct. 12, 2001

Related U.S. Application Data
(60) Provisional application No. 60/240,393, filed on Oct. 12, 2000.

(51) Int. Cl. G05B 19/18

(52) U.S. Cl. 700/2; 700/6

(57) ABSTRACT

The Field Programmable Instrument Controller (FPIC) is a stand-alone low to high performance, clocked or unclocked multi-processor that operates as a microcontroller with versatile interface and operating options. The FPIC can also be used as a concurrent processor for a microcontroller or other processor. A tightly coupled Multiple Chip Module design incorporates non-volatile memories, a large field programmable gate array (FPGA), field programmable high precision analog to digital converters, field programmable digital to analog signal generators, and multiple ports of external mass data storage and control processors. The FPIC has an inherently open architecture with in-situ reprogrammability and state preservation capability for discontinuous operations. It is designed to operate in multiple roles, including but not limited to, a high speed parallel digital signal processing; co-processor for precision control feedback during analog or hybrid computing; high speed monitoring for condition based maintenance; and distributed real time process control. The FPIC is characterized by low power with small size and weight.

This application claims the benefit of Provisional Patent Application Ser. No. 60/240,393 filed Oct. 12, 2000.

### FEDERALLY SPONSORED RESEARCH

This invention was made with Government support under SBIR Contract No. F29601-99-C-0007 awarded by the United States Air Force Research Laboratory. The Government has certain rights in the invention.

### SEQUENCE LISTING OR PROGRAM

Not Applicable.

### BACKGROUND

1. Field of the Invention

The present invention relates to the field of process and machine diagnostics, prognostics and control, and more specifically to a remotely programmable electronic component constructed of various commodity microcircuits that provide means for a field programmable distributed control system employing unclocked asynchronous multi-threaded process control that exploits the tight coupling of components from non-similar processes and non-volatile storage for numerous monitoring/controlling applications under conventional and exacting conditions requiring high speed operations. Further, the electronic components that embody the present invention can be packaged in the form of a small Multi-Chip Module (MCM). “Small” in this case refers to an MCM that can be constructed in a form factor comparable or smaller than a popular integrated circuit processor chip used in personal computers.

2. Description of the Prior Art

The following discussion of the prior art and its limitations. It also discusses those aspects not covered by prior art that are addressed by the present invention, which are the well spring for the objects of the present invention. For brevity, only the most significant limitations of each category of prior art are included.

Our search of patent databases discovered that Lyke's patent of November 2000 is most recent in the field of microcontrollers. The Preliminary Patent Disclosure (PPD) referenced for this application predates Lyke's patent date. The following paragraphs disclose differences and innovations related to Lyke's patent which also by reference discloses improvements accomplished over prior art. The following paragraphs describe improvements on Lyke's most recent patent.

The preferred embodiment of the present invention allows use of an external microprocessor or other CPU to start and control the actions of the FPIC. However, there is a serious disadvantage of using a dedicated commodity microprocessor because there are significant processing and addressing limitations for 8 bit and 16 bit architectures. The present invention eliminates the need for a dedicated microprocessor because the FPGA can be started with an initial processor configuration at start-up. Thereafter the FPGA can be reconfigured on the fly with multiple processors of 8, 16, 32, and 64 (or other) architectures.

Lyke's patent incorporates an analog ASIC; a resistor ASIC. The FPIC eliminates these components by redesign. This is a significant and cost effective improvement as the ASIC devices are very costly.

Lyke's AIC has a single fixed integer arithmetic 8 bit processor. This is a serious limitation because of the difficulty in performing floating point calculations, trigonometric functions, and other mathematics. If integrated with a processor in an application circuit, the present invention provides a multi-purpose separately functional Field Programmable Gate Array (FPGA) that acts simultaneously as a floating point co-processor and as a parallel processor with internal or separate external clock or as an asynchronous parallel processor that operates at the raw speed electricity flowing through its array of semiconductor gates. In other words, the FPIC becomes a freely re-configurable and separately programmable multipurpose multiply-parallel processing digital system for the microcontroller.

Lyke's design is based on a single 8 bit fixed point 25 mhz processor clocked at a relatively slow 12 megahertz and 10 megahertz speed by two internal voltage controlled oscillator circuits for high-frequency and for low frequency operation. The AIC incorporates internal oscillators that provide only relative speed clocking as the clock speed is significantly affected by thermal conditions. This is a serious limitation when accurate clocking is required. The present invention permits use of precision clocks, which is a significant improvement in clocking over that accomplished in the design the AIC. The present invention has provision for an integral precision real time clock to accurately control processing and provide time data for distributed control and transfer of processed information.

Quist, et al U.S. Pat. No. 6,199,018 discloses a network of multiple computers that perform machine diagnostics using local monitoring devices. These include sensor sets and sensor circuit boards. The patent discloses using a failure detection circuit and an insulation failure sensor along with various other circuitry interfaced to individual sensors. The programming of the microprocessors and computers that comprise the diagnostic network are all of the static nature that must be reprogrammed to change functionality. This is a significant disadvantage considering the cost of programming persons anad the delays required to implement such programming. The present invention provides field programmability and automatic instantiation of many of the circuits used in Quist's patent. The field programmability of the present invention enables the entire network to reconfigure and adapt to new electronics and to new algorithms to achieve a diagnostic network. This is a significant improvement in time and cost.

Rostoker et al. in U.S. Pat. No. 5,563,928 discloses a free-running relaxation oscillator and integrated circuit dye built as a multi chip module. The current invention can instantiate all components except the gated counter in gates of the gate array. This is a significant advantage over Rostoker's patent.

Rostoker et al. in U.S. Pat. No. 5,678,057 discloses a multi chip module circuit comprised of a substrate a plurality of integrated circuit processors mounted on the substrate and an advanced programmable interrupt controller system for distributing interrupts to the processors. The APIC system for comprises a plurality of local units for prioritizing and passing interrupts to the processors respectively, and an Input/Output (I/O) unit for feeding interrupts to processors to which the interrupts are addressed. Electrical conductor patterns are formed on and between dielectric layers of the substrate for interconnecting the processors, the local units and the I/O unit. The present invention eliminates all of the above components by replacing them with gate array equivalents that have tighter coupling and removes the requirement for special programming of the processor units. This is a significant advantage over Rostoker's patent.

Newman's et al. U.S. Pat. No. 6,049,748 discloses an electronic control system as an inline module for addition to or partial replacement of automotive vehicle seat control systems for providing massage and improved features of functional control, especially human lumbar massage and diagnostics. The module provides the following improved functions and features: an enhanced driver for automatic lumbar massage, or user taught lumbar massage cycle, and a transparency simulator for low power standby operation, motor stall protection, open motor circuit detection, short motor circuit protection, motor low current protection, motor over current protection, seat position sensor malfunction detection, electrical motor noise attenuation, electrical noise filtering, and also other options. These improvements do not require alternative wiring harness changes and do not affect existing operations of a memory or no-memory seat control mechanism. The present invention is able to eliminate all digital circuitry by replacing it with instantiated gate arrays contained in a single FPGA chip. This is a significant advantage over Newman's patent.

The FPIC incorporates a very large scale integration Field Programmable Gate Array able to be configured as a multiple threaded, parallel computer with multiple heterogeneous processors of various bit precision. The FPIC with the FPGA as processor is autonomous and can be operated with an internally generated clock pulse generated by a clock register formed of gates.

The present invention has the feature that if it is desired to use the microcontroller to control the FPGA, the microcontroller can assume full control even controlling the clock speed; or act as an monitor for the FPGA, providing intermittent data feed and results receiving and watchdog functions. The FPGA operates either independently or under control of the CPU performing calculus and algorithms. The fact that the FPGA can be made to operate as a plurality of processors means that the FPGA can act as a floating point coprocessor to the CPU in addition to performing complex operations for high precision digital signal processing that are impossible due to the limitations of the 8 bit processor in the AIC.

Due to their fixed interconnectivity, most microcontrollers lack the ability to reconfigure signal lines. Lyke's patent incorporates a MEMS switch to reconfigure the signal lines. The FPIC eliminates the need for such switching devices as the function of reconfigurable switching is inherent in the FPGA.

### OBJECTS AND ADVANTAGES

Systems that utilize computers, electronic process controllers and microcontrollers are used to monitor and control diverse mechanical, chemical, and mixed mode processes. Electronic devices used to implement such a system represent a class of computing devices that capture and process signals, and use the results to modify the controls of the process being managed. Prior art recent to the current time are comprised of computing devices that use computer algorithms embodied in software programs to accomplish diagnostics, prognostics, and control. The process of innovation continues to shrink the size of electronics of computers and computerized controllers to the extent that there have evolved a family of “microcontrollers” with ever smaller and smaller size and increasing functionality.

Current art of computers, microcontrollers and other programmed devices are problematic as by the nature of technology innovation the electronic technology on which they are based are replaced by new improved technology offering improved speed, cost, size, and architecture functionality. This leads to the fact that monitoring systems and the microcontrollers and the architectures by which they are constructed quickly become obsolete, and the programming techniques used in them become archaic. There is a pressing need to move from device, specific programming languages and preconfigured electronic devices used in said systems, to a freely and remotely programmed technology that does not rely on preprogrammed instructions that significantly improves on the current art. For brevity in this application, we call the modular electronics of the present innovation a Field Programmable Instrument Controller (FPIC) and the application of the FPIC in a distributed control system a Field Programmable Control System (FPCS).

It is important to recognize and understand that FPGA by their nature enable freely instantiating and erasing processing devices built with the gates of the gate array. Similarly FPGAs have the capability for constructing and deconstructing multiple instances of processing architectures of any bit width. Any microcontroller-like device constructed with a large scale FPGA will have significant and cost effective advantages arising from the aforesaid capability and the inherently open architecture and flexibility of being remotely programmable.

The primary object of the present invention is to leverage the availability of large scale FPGA to replace the pre-programmed functionality of current art microcontrollers with freely and remotely programmable architectures of similar functionality and invent the means for implementing an innovative control system built upon such FPGA based technology.

The present invention, called for brevity a field programmable instrument controller (FPIC), embodies the functionality of microcontrollers and instrumentation controllers in a field programmable, high speed, general purpose instrumentation device with functionality freely implemented in a large scale FPGA configured with commodity digitizers, digital to analog converters, memory, and input/output devices.

Another object is to take advantage of the fact that myriad electronic devices can be constructed and deconstructed “on the fly” with gates of portions of the gate arrays. Such devices include tightly coupled highly adaptive parallel processors and electronic hardware circuits, namely programmed or firmware-controlled State-Machines and Sequencers or combinatorial asynchronous or sequential Boolean logic circuits, or programmed arrays of gates.

It is another object to invent an electronic controller with the means whereby circuit and processors can be being instantly activated from predefined constructs stored in local memory and tightly coupled as in-situ networks able to communicate with every other then active processor or circuit element constructed in the FPGA.

Another object of the present invention is to provide a mechanism for overcoming the limitations of prior art by providing a small footprint means for a very high speed digitizing and parallel processing, a capability needed to interface and keep pace with purely analog or optical computing architectures that operate at the speed of flow of the electricity or light unlike dedicated digital processor architectures of the current art. Processors with purely optical or analog computing architectures.

Another object is to improve on Lyke's AIC invention by adding additional functionality that is made possible with dynamic reconfigurability of the FPGA.

### SUMMARY

The present invention is a high precision micro-electronic system that provides the means for real time adaptive parallel multi-processing to monitor and control a plurality of distributed processes without the need for dedicated microprocessors. More particularly it relates to an electronic circuit that is a field reconfigurable computing apparatus incorporating a field programmable gate array capable of hosting simultaneously a plurality of parallel computing processes for the purpose of controlling a plurality of distributed or colocated processes. The features and functionality are achieved by innovations that include adaptive “on the fly” reprogrammability, multiple instances of parallel algorithm processing, precision digitizing of analog input signals, dynamically changeable programming, and reconfigurable routing of digital and analog output signals without the aid of external devices. The FPGA is capable of creating instances of electronic hardware circuits, namely programmed or firmware-controlled State-Machines and Sequencers or combinatorial asynchronous or sequential Boolean logic circuits, or programmed arrays of gates. In accordance with the present invention, the apparatus is constructed of commodity integrated circuits so that individual semiconductor chips can be used to design and manufacture the FPIC as a multi-chip module (MCM), as an Application Specific Integrated Circuit, or as a conventional electronic system.

### DRAWING FIGURES

FIG. 1 is a diagram that describes the functions and components of the FPIC in the preferred embodiment. The diagram elements within the dashed lines represent the plurality of the paths, components and functions of the FPIC. The figure also contains instances of components external to the FPIC that are optionally used a) to control the FPIC with an external processor, and b) to store digital information in an external memory device.

FIG. 2 describes diagrammatically the electronic circuitry of the first prototype of the FPIC constructed from a commercially available developer kit for a 1 million gate FPGA and non-volatile memory, digitizers, and other electronic hardware described in this application.

FIG. 3 describes diagrammatically the implementation of high speed digitizing with the “Smart” field programmable analog to digital converter.

FIG. 4 describes diagrammatically how individual FPIC can be linked in a distributed network interfaced with other FPIC as well a centrallized computer, various processors, microcontrollers, and computing devices to accomplish a field programmable network for diagnostics, prognostics, and process control. The program is diagrammatic with respect to the network architecture because the connectivity is dependent on the capabilities of the technology used.

FIG. 5 describes diagrammatically the functional flow of data and controls in the FPIC. The numbers and elements are consistent with those used in FIG. 1.

### REFERENCE NUMERALS IN DRAWINGS

1 analog input

2 field programmable agile analog to digital converters (FP-A/ADC)

3 field programmable digital to analog (FP-DAC) converters

4 analog output signals

5 non-volatile memory

6 external memory device

7 field programmable gate array (FPGA) circuit

8 external processor or microcontroller

9 program memory address control logic (gate array)

10 static random access program and data memory (gate array)

11 IEEE 1149 (JTAG) programming interface circuit

12 digital signal processor engine control block (gate array)

13 programmable interface control block (gate array)

14 FPGA control bus

### DESCRIPTION—PREFERRED EMBODIMENT

The preferred embodiment of the FPIC provides an extremely compact, low-power alternative to simple system control applications where a highly flexible, highly functional solution with low external component count is required. The FPIC has many features that make it possible in some cases to use no additional pre-scaling, timing, and other supplemental electronics. As such, the FPIC is similar to a “system-on-a-chip” and can readily be manufactured using integrated circuit die to create size similar to a chip in size, weight, and physical configuration, but through a tightly coupled MCM implementation, transcends the functional capability of a single integrated circuit. The FPIC a very large Field Programmable Gate Array (FPGA), high speed precision digitizers, digital to analog converters (DAC), volatile and non-volatile memory storage systems, analog signal interface circuits and digital interface circuits able to be configured on a single tightly coupled MCM to achieve its stand-alone capabilities.

These capabilities include ultra-low power requirements, extremely small size and weight, versatile functionality, and the ability to operate in extreme environments. The design takes advantage of entirely commercially available electronic components to eliminate need for application specific integrated circuits and discrete components found in former embodiments of microcontrollers.

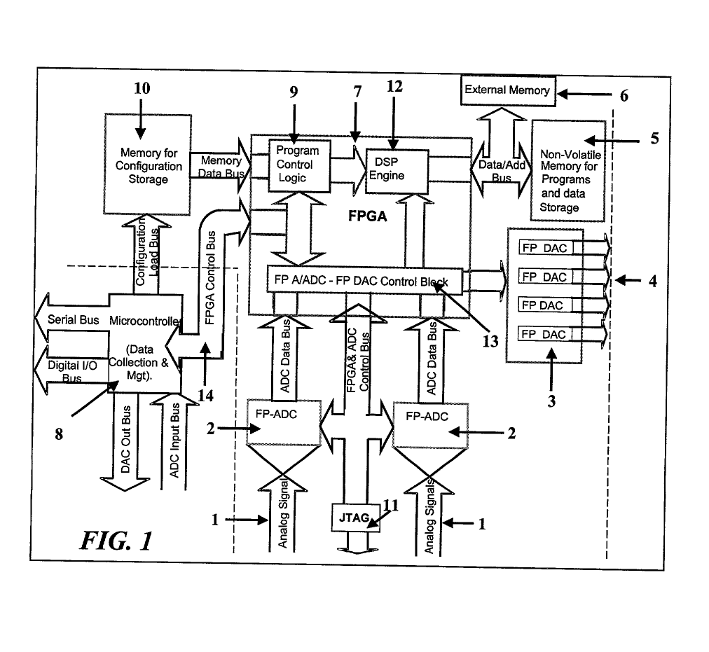

FIG. 1 depicts the FPIC block diagram schematic, illustrating novel design features. These features include a large number of analog inputs 1 handled by a pair of alternating at very high speed precision Agile Analog to Digital Converters (A/ADC) 2; analog output signals driven by multiple field programmable Digital to Analog converters (FP-DAC) 3 producing analog output signals 4. Another feature is a input/output port supporting communication to digital bus for external FPGA control such as by an external microcontroller 8.

There is a large non-volatile program and data storage component 5 within the FPIC. There is a large Field Programmable Gate Array (FPGA) circuit 7 with connections to interface signals to an external processor or microcontroller 8. Program addresses are accomplished by an address partitioning and control circuit 9 directing programs with addresses stored in a large non a larger static memory storage system for program and data storage 10 that makes possible “on-the-fly” creation of a plurality of temporary parallel heterogeneous processors in the FPGA space. The FPGA 7, FP-DAC 3 and FP-A/ADC 2 are programmed by loading programs via a programmed interface circuit 11. The programs are stored in the non-volatile random access program storage component 5. There is an interface to an external memory device 6 such as a high speed flash memory card. The FPIC also has in-situ reprogrammability and state preservation capabilities, and smart-signal adaptation capability on selected digital discrete interface signals. The transfer of digitized signal data from the FP-A/ADC 2 to the FPGA as well as data from the FPGA to the FP-DAC 3 is accomplished with a field programmable control block 13 programmed for that purpose by signals from the programming interface device. 11 Control blocks programmed within the FPGA handle digital data and commands associated with an external processor 8 as well as signals for the digital signal processing (DSP) engine control block 12.

A combination of large non-volatile memory storage systems 5 supporting parallel processors created on-the-fly in an FPGA 7 and communication to external high speed nonvolatile memory 6 such as flash memory is a cornerstone of FPIC operation. The FPIC is upgradeable and scaleable as new memory; FPGA 7 and other components of the FPIC become available. Yet, all the components can be customized and tightly coupled within an MCM for maximum performance. A typical FPIC contains at least two non-volatile memory units 5 and 10 each with a minimum of one megabyte of non-volatile memory each, usually flash, Dynamic Random Access Memory (DRAM) or electrically erasable programmable memory based. The non-volatile memory is used for program control storage, program storage and data storage, which can be changed repetitively, limited only by the fatigue mechanism associated with the non-volatile device.

### OPERATION—PREFERRED EMBODIMENT

Operation of the invention is specific to the application to which it is used. However, in general the operation is to provide precision control of real time processes in a manner that is similar to that employing a microcontroller. That is the device serves a multitude of purposes in applications where it is beneficial to digitize analog signals associated with processes in near real time, analyze said digitized analog signals according to digital signal processing algorithms, perform messaging and display function (if any), and based on programmed algorithms generate feedback signals to better control the said process or processes.

### REDUCTION TO PRACTICE

During 1999 and 2000 we created a breadboard and brassboard of the FPIC with the goal to achieve high-speed analog data acquisition and control from focal plane array with signal processing and digitizing of analog feedback signals to accomplish operating at 100 frames per second.

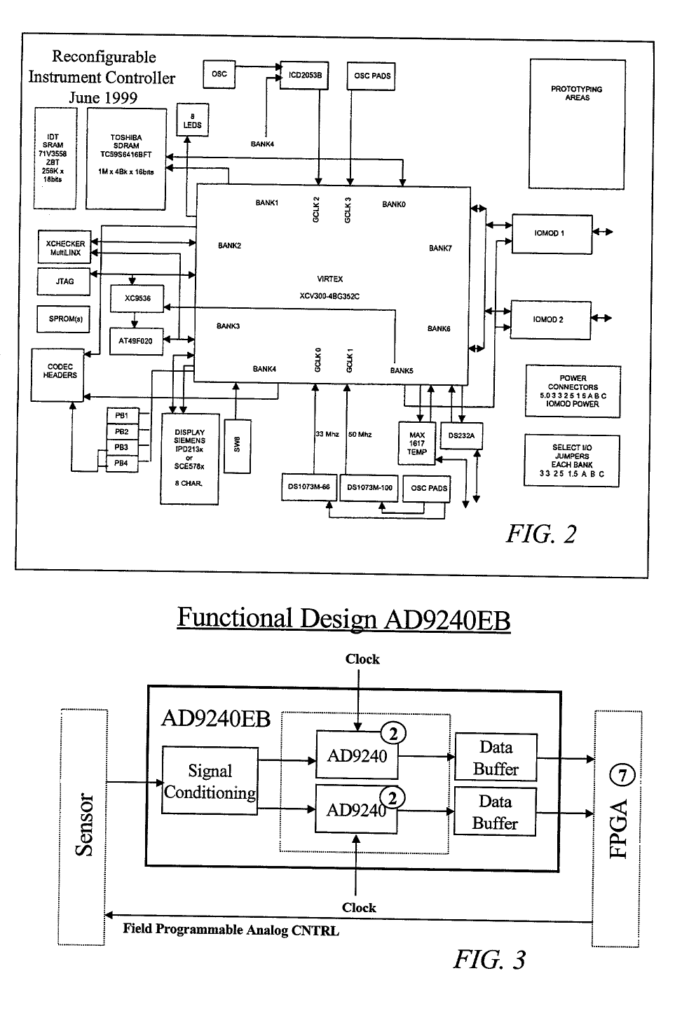

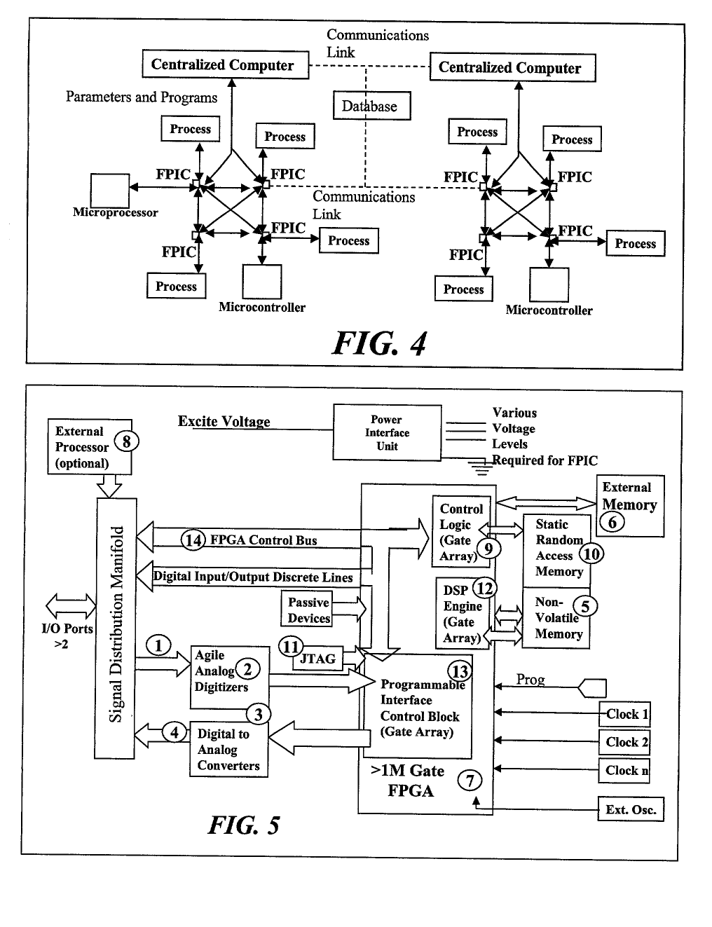

Reduction to practice was accomplished through simulation using a technique called virtual prototyping followed by constructing a prototype comprised of commodity electronic components and software written for an application. The virtual prototype was created that used an FPGA emulator produced by Xilinx Corporation. The breadboard circuit to prove the concept was constructed with a Xilinx VW300 virtual workbench with 300,000 gate FPGA. The VW300 workbench has a suite of developer-oriented components such as a Siemens eight character display, Toshiba 1M×48 k×16 bits SDRAM (TC59S641BFT) and an IDT SRAM (Model 711V3558) with 256K×16 bits of storage for program storage and program configuration control. We used a Sentient Instrument Controller™ (SIC) as the control processor. Reference FIG. 2 for a diagram of the components.

The accommodation of commodity components is not considered a compromise since the FPIC can benefit from the substantial industrial investment in such components that are as dense as the state-of-the-art in silicon processing permits. Furthermore, the primary or core program instantiated from memory 10 onto the FPGA 7 can be programmed to power down the non-volatile devices when power consumption needs to be minimized, so that the effects of non-optimized drivers (those not designed with tightly coupled methodologies) that are “power hungry” can be negated.

Once the concept was proven, we built the FPIC brassboard with full functionality according to the preferred embodiment of this application.

Several firms produce large FPGA as commodity. We selected a Xilinx Virtex: XCV1000-4BG560, with 2.5 Volt power, a density of one Million (1,124,022) system gates and with rated system performance up to 200 MHz. We purchased and integrated 1 Megabits of SRAM as FFT Memory. We used four data line level's for four low-skew clock distribution nets. The FPGA memory was organized in 8 banks with variable reference voltages per bank. We selected a XC9500 Xilinx FPGA to provide alternative programming capability with a MultiLINX XCHECKER® with slave serial and selectMAP functions for multiple FPGA program mapping and control.

FPGA software programs used in the breadboard were loaded into the FPGA by means of the JTAG connector. In addition other programs were created with a Xilinx program generator, compiled and loaded into memory storage of the FPGA using the JTAG connections.

Analog to Digital Converters:

Dual AD9240 ADCs were used to provide ping-pong digitizing which provided additional analog settling time, a key consideration of high speed digitizing.

Digital to Analog Converters (DAC):

After review of several DAC circuits, a target device was identified as the MAX5253 with four individual DAC's are included in a single package

Digitally Programmable Potentiometer (DPP):

The AD8403 device by Analog Devices Corporation was selected and integrated into the brassboard design. The DPP are used in conjunction with the A/D's, DAC, and FPGA signal processing module for various sensor applications.

FPGA Program Controller:

It was determined that a complex programmed logic device (CPLD) would enable the stand-alone capability, as well as, the enabling reconfigurability. The said CPLD devices were ordered, an overall design was determined and the sub-circuit design completed.

Memory Controller/Memory Architecture:

Several alternative designs were evaluated. Using VHDL and Verliog designs of alternative controllers. The memory controller circuitry was designed for dual port capability, essential for several DSP applications. In addition, the memory architecture was designed to support reconfiguration from any memory element connected to the “memory bus”. While adding additional design complexity, the additional feature supports several applications.

Synchronization:

The embodiment included 4 delay locked loop circuits (DLL) to prove a maximum of four low-skew clock distribution nets.

RS232 Port:

A RS232 port was an added feature of the breadboard development system and an attractive feature retained in the brassboard.

Flash Memory:

A flash memory was selected for the non-volatile configuration programming memory. The Virtex FPGA requires approximately 6 MB for configuration programming. Since 8 MB commercial device exist meeting this requirement, there were several possible “upgrades” to provide additional capability. To accommodate the XCV100 we selected Atmel AT49F080 8 Mb Flash Memory. Alternatives were readily available such as SDRAM (64 Mb), SRAM (16 Mb), and SB RAM (4 Mb). The alternatives included adding a “flash controller module” design to the FPGA to enable the use of the remaining space as User Flash—and even upgrading the size to 16 MB to provide more NVM space. We evaluated alternative designs and developed a concept for a reconfigurable architecture which supported multiple design capability at boot-up, as well as, “reconfiguration on the fly”.

For Input/Output connectors we used three SCSI-II 50 pin I/O edge connectors, enough to service the Sensor Control Bus. SIC microcontroller bus, and general I/O bus. We set the test board with IEEE 1149 (JTAG) and MultiLINX programming devices, and an Atmel AT49F080 8 Mb Flash Memory and a MultiLINX to provide a slave Serial interface and SelectMAP.

We connected two Dallas Semiconductor® oscillators as clocks, out of a maximum of 4 Clocks, two out of four were populated providing 50 MHz (DS1073M-100) and 33 MHz (DS1073M-66). Another clock was connected to Bank 1 and Bank 0 using a ICD2053B oscillator.

For digitizing we used AD9240 which provide 14 Bit conversion at 10 million samples per second. The AD9240 minimize signal noise and reduce power supply requirements. The AD9240 were interconnected in parallel with alternating clocks to accomplish ping/pong sampling for maximum throughput with minimum data aliasing. The AD9240 supports differential and single-ended operation, and have an external voltage reference for pre-conditioning signal input needed for sensor signal conditioning interfaced to a sensor electronics card to provide maximum flexibility and minimum size for product MCM design.

The FPIC brassboard was successfully tested as a stand-alone unit providing complex digital signal processing to provide feedback control a set of 8 by 8 micro mirrors in a MicroElectro Mechanical System (MEMS). The Xilinx 1 Megagate FPGA used in the first reduction to practice of the FPIC can be operated at greater than 1 megahertz. In tests, the FPIC operated at 200 mhz was able to complete 10,000 processes per second where a microcontroller like the AIC could achieve only a fraction of that amount. The increase in speed is partially due to the increased speed of the precision digitizers, but mainly due to the 100 fold increase in processing speed of the FPGA over that of conventional microcontrollers.

Next, the FPIC was tested in slave mode controlled by a Sentient Instrument Controller which is an advanced microcontroller. The FPIC was tested as a sychnronous parallel coprocessor controlled by the clock of the SIC. This FPIC performed digital signal processing. The FPIC operated according to expectations.

### CONCLUSION, RAMIFICATIONS, AND SCOPE

In conclusion, the information disclosed in this application discloses the idea, embodiment, operation of the invention in order to support the stated claims. The scope of the claims include a versatile field programmable instrument controller (FPIC) constructed by leveraging current FPGA technology; process control utiliziing the FPIC technology, and a field programmable system of distributed process control that takes advantage of the features of the FPIC to intercommunicate data, information, and knowledge as a collective.

The ramification of the present invention is that it makes possible replacing cumbersome and arcane microcontrollers that incorporate dedicated microprocessors with fixed bit width architectures controlled by fixed programming with a scaleable and expandable architecture based in field programmability and real time instantiation of electronic circuits for flexible configuration of process control. The result is significant savings in cost, upgrade, replacement, and especially writing of computer programs.

The scope of the present invention, while described with respect to networked process control, includes diverse applications such as condition based maintenance, precision logistics, monitoring of persons and other animals for medical or scientific reasons, situation awareness, robotics, autonomous vehicles, unmanned vehicles and spacecraft.

I claim:

1. An electronic control apparatus called for convenience a Field Programmable Instrument Controller (FPIC) for controlling the processes of a process system, said control apparatus comprising:
a plurality of processing elements each especially adapted to perform special tasks, each said processing elements is a process represented by software programs, or algorithms or by specific hardware elements, namely programmed or firmware-controlled State-Machines and Sequencers or combinatorial asynchronous or sequential Boolean logic circuits, or programmed arrays of gates whereby each said processing element being activated “on the fly” is able to communicate with every other then active processing element;
a means wherein said process elements operate in parallel or serial manner in plurality of computing architectures instantiated “on the fly” in at least one Field Programmable Gate Array (FPGA);
said computing architectures being of bit size and functionality as defined in a program definition algorithm stored in electronic memory of the said electronic control apparatus for the purpose of embodiment of the architecture in a portion of said FPGA;
at least one said processing element contained in said control apparatus which has the capability of interfacing to another FPIC or other processor selected from but not limited to members of the group of processors, microcontrollers, microprocessors, or computers; and
said processing elements which all or severally assume roles needed to create required process control functionality, whereby at least one processing element represents the specific functionality of FPIC memory allocation storage and retrieval, at least one processing element covers all FPIC processing related with interconnected real-time processing and hardware interfaces, at least one processing element exercises all human interfaces, at least one processing element covers FPIC specific functionalities related to controlling processes, and at least one processing element functions as an access point connecting to FPIC external extension units selected from members of the group consisting of but not limited to FPIC, microcontrollers, microprocessors, macroprocessors, FLASH memory, PCMIA, data busses, networks, and communication devices.

2. Electronic control apparatus as in claim 1, wherein one of the processes operating in one or more processors instantiated in said FPIC acts as a common access point.

3. Control apparatus as in claim 1, wherein said processing elements are represented by specific software and hardware elements operating a plurality of individual processors instantiated in said FPIC.

4. Control apparatus as in claim 1, wherein said processing elements are represented by specific hardware elements, namely micro-controller architectures, programmable or firmware-controlled State-Machines and Sequencers or combinatorial asynchronous or sequential Boolean logic circuits instantiated in a plurality of interfaced external electronic control apparatus or processors.

5. Control apparatus as in claim 1, wherein said processing elements are represented by software mapped to a single or to multiple processor architectures instantiated in said FPIC, said software operating asynchronously or synchronously in series or in parallel fashion.

6. A distributed control system for controlling a plurality of processes, the system comprising a plurality of local monitoring devices, having:
sensors for collecting local data and signals concerning at least one process associated with the monitoring device;
a local data processor for receiving and communicating the local data from the sensors concerning its associated process;
a centralized data processor coupled to a plurality of local devices that provide means for monitoring, diagnosing, prognosing and controlling;
the said centralized data processor providing the means for receiving from each local controlling device the local data concerning its associated process, for generating a set of weighted parameters for each local controlling device, and for communicating the set of weighting parameters to each local controlling device,
the local processor for each local controlling device further for receiving the set of weighting parameters and processing the local data using the set of weighted parameters for local diagnostic and control purposes, and
at least one the local controlling devices being one of the electronic control apparatus as in claim 1.

7. The distributed control system as in claim 6 wherein processing elements assume roles, a first control process represents the specific functionality of system support applications, a second control process covers all applications related with real-time networks and direct hardware controls, a third control process exercises all human interface applications and the electronic control apparatus specific functionalities, and a fourth control process functions as a network access point connecting to electronic system external extension units and to local area networks (LAN) or wide area networks (WAN), or wireless networks.

8. The distributed control system as in claim 6 wherein the system support applications are chosen from a group consisting of power management, wake-up and sleep control, system vitality monitor, and system fault handling

9. The distributed control system as in claim 6 wherein the direct hardware is chosen from the group consisting of electronic, electromechanical, electro-optic or electro-hydraulic control systems.

10. The distributed control system as in claim 6, wherein the human interface applications are chosen from the group consisting of physical input/output units, visual input/output units and voice input/output units.

11. An electronic control system for controlling the process of a processing system comprising:
a least one of said control apparatus in communication with a plurality of other electronic processors each of which performs a predetermined function and each of which is able to communicate with remaining ones of said control elements.

12. Control system as in claim 11, wherein the link ports use standard data link protocol and/or the physical representation thereof.

13. Control system as in claim 11, wherein the arbitrated link uses any standard bus access technique.

14. Control system as in claim 11, wherein the control elements are implemented in software operating on processors of said FPIC.

15. Control system as in claim 11, wherein the control elements are implemented using capability of said FPIC in combination capability of other electronic control elements some of which can be another instance of said FPIC.

16. Control system as in claim 11, wherein the tetrahedral interconnection geometry provides simultaneous multi-path communications among control elements.

17. Control system as in claim 11, wherein the tetrahedral interconnection geometry provides real-time capability to electronic control unit (ECU) or central processor unit (CPU) near components, subsystems, and networks.

18. Control system as in claim 11, wherein the tetrahedral interconnection geometry provides secure access to system external units via at least one of a network and wireless connection.
